(19) United States
(12) Patent Application Publication
(10) Pub. No.: US 2016/0112225 A1
(43) Pub. Date: Apr. 21, 2016

(54) Measuring Waveforms With The Digital Infinite Exponential Transform

(71) Applicant: Digital Harmonic LLC, Stevensville, MD (US)

(72) Inventor: Frederick M. SLAY, Okatie, SC (US)

(73) Assignee: Digital Harmonic LLC, Stevensville, MD (US)

(21) Appl. No.: 14/885,693

(22) Filed: Oct. 16, 2015

Related U.S. Application Data
(60) Provisional application No. 62/064,627, filed on Oct. 16, 2014.

(51) Int. Cl. H04L 27/156

(52) U.S. Cl. CPC H04L 27/156

(57) ABSTRACT

A method is performed of selecting a signal of interest from a compound signal. The method includes generating a matrix and initializing a first row of the matrix to zero. The compound signal is obtained as a digital waveform signal, with sampling rate S samples per second. For each sample of the digital signal, a new entry is recursively computed for the matrix. For each frequency bin in the matrix (where f is the center frequency of the bin) the value in the new row is computed by multiplying the value for that bin in the previous row by the complex number r*e^{i2πf/S} and adding the new signal sample multiplied by a real constant. The method includes identifying the signal of interest from the matrix, whereby an uncertainty of which frequency bin the signal of interest exists in is eliminated.

### CROSS-REFERENCE

This application is related to and claims the benefit of US Provisional Patent Application No. 62/064,627 filed Oct. 16, 2014, which is incorporated by reference in its entirety.

### FIELD OF THE INVENTION

The invention relates to measurement and time-frequency-amplitude-phase analysis of waveforms and compound waveforms.

### BACKGROUND OF THE INVENTION

Given a compound waveform, it is desirable to accurately measure the waveform and its components, which may have been spawned by several sources. This is difficult when the waveform includes signals produced by different sources overlapping in time and frequency, low energy signals eclipsed by higher energy signals, rapid changes in frequency, and/or rapid changes in amplitude.

Analysis of waveforms is traditionally accomplished in the time, frequency, amplitude and phase domains. Typically, these real-world, analog waveforms are first captured digitally as amplitude samples in time, then a series of transforms is used to measure the signals. A variety of techniques have been developed to extract frequency/amplitude/phase information from the time-series data. Unfortunately, representing how the frequency, amplitude and phase change with respect to time can be challenging, particularly when there are abrupt frequency and/or amplitude changes, or signals from multiple sources occupy the same time and frequency regions.

One common method for obtaining time, frequency, amplitude and phase information is using one or more computer processors to perform a series of Discrete Fourier Transforms (DFTs). The individual DFTs in the series are called Short Term Fourier Transforms (STFTs). Each DFT transforms a portion of the input signal (over a window of time) into an array of complex numbers, each complex number representing the amplitude and phase for a particular frequency in that time window.

There is a tradeoff between frequency and time resolutions resulting from the length of each DFT. The time window inspected by a DFT is equal to its length; a long DFT inspects a larger time window than a short DFT. This larger time window makes a long DFT slow to react to changes.

Longer DFTs have higher frequency resolution but lower time resolution. Shorter DFTs have higher time resolution but lower frequency resolution. Because of this tradeoff, practitioners have sought modified DFTs or other alternative methods to accurately represent dynamic, time-varying waveforms with good resolution in both time and frequency.

### SUMMARY

Systems and methods for implementing a transform having significant advantages over a DFT for many applications are described herein. This new transform is fundamentally different mathematically—it is not the same as a Fourier Transform when written as an integral. Also, it is computed differently in a digital embodiment, according to an embodiment. For many applications, the new transform is dramatically faster to compute than a DFT. The new transform achieves better time, frequency, amplitude and phase resolution.

For simplicity, the word “row” is used herein to represent a time slice in a matrix. Similarly, the word “column” is used herein to represent each frequency bin in the matrix. Thus, the matrix may consist of cells, with each cell being in a specific row (time slice) and column (frequency bin). Each cell will contain a value (e.g., a complex number representing the signal strength and phase). Other matrix topologies are possible as would be understood to a person skilled in the art.

The words “signal” and “waveform” may be used interchangeably herein and have the same meaning. A compound waveform consists of multiple waveforms (signals) mixed together. While this disclosure refers to signals in the audio frequency range, the embodiments disclosed herein are not limited to any particular frequency range or complexity. Any application that measures waveforms/signals as part of its process may be assisted by the embodiments disclosed herein.

According to an embodiment, a method is performed of processing a signal of interest from a compound signal. The method includes generating a matrix wherein each column is associated with a corresponding frequency bin of a plurality of frequency bins, each frequency bin extending over a portion of a bandwidth of the compound signal and initializing a first row of the matrix to zero. The compound signal is obtained as a digital waveform signal, with sampling rate S samples per second from data storage or from conversion of a physical analog signal received from an analog source or is captured by a physical analog device. For each sample of the digital signal, a new entry is recursively computed for the matrix. For each frequency bin in the matrix (where f is the center frequency of the bin) the value in the new row is computed by multiplying the value for that bin in the previous row by the complex number r*e^{i2πf/S} and adding the new signal sample multiplied by a real constant. The method includes at least one of storing the matrix, transmitting the matrix, displaying the matrix, and identifying the signal of interest from the matrix, whereby an uncertainty of which frequency bin the signal of interest exists in is eliminated.

According to another embodiment, the amplitude of the output is normalized by setting the real constant (that the new signal sample is multiplied by) in the above process to 2*(1−r).

According to another embodiment, another step is added to the process above to correct the phase. The complex value in each call in the matrix, in the row for the n'th sample, is then multiplied by e^{-i2πnf/S}.

According to an embodiment, a method is performed of processing a signal of interest from a compound signal. The method includes generating a matrix wherein each column is associated with a corresponding frequency bin of a plurality of frequency bins, each frequency bin extending over a portion of a bandwidth of the compound signal and initializing a first row of the matrix to zero. The compound signal is obtained as a digital waveform signal, with sampling rate S samples per second from data storage or from conversion of a physical analog signal received from an analog source or is captured by a physical analog device. For each sample of the digital signal, a new entry is recursively computed for the matrix. For each frequency bin in the matrix (where f is the center frequency of the bin) the value in the new row is computed by multiplying the value for that bin in the previous row by the r, where r is a constant greater than zero and less than 1, and adding the new signal sample multiplied by a real constant and by the complex number e^{-i2πnf/S}. The method includes identifying the signal of interest from the matrix, whereby an uncertainty of which frequency bin the signal of interest exists in is eliminated.

According to another exemplary embodiment of the invention, in any of the above processes, the matrix is not created directly. Rather, the transform is created in an array, which is initialized to zero and then, for each signal sample, the array updated using the above formulas. The matrix is created by copying the array into a new row of the matrix after each update.

According to another embodiment (of just the phase correction invention), in a matrix computed using a DFT or FFT, the row corresponding to the n'th sample in a signal is multiplied by e^{-i2πnf/S}.

According to another embodiment, a method is performed of processing a signal of interest from a compound signal. The method includes generating an array wherein each element of the array is associated with a corresponding frequency bin of a plurality of frequency bins, each frequency bin extending over a portion of a bandwidth of the compound signal and initializing the array to zero. The compound signal is obtained as a digital waveform signal, with sampling rate S samples per second from data storage or from conversion of a physical analog signal received from an analog source or is captured by a physical analog device. For each sample of the digital signal the array is recursively updated by, for each frequency bin, where f is the center frequency of the bin, multiplying the previous value for that bin in the array by the complex number r*e^{i2πf/S}, where r is an exponential decay constant greater than zero and less than 1, f is the center frequency of the bin, and S is the sampling rate, and adding the new signal sample multiplied by a real constant. The method includes saving the updated array as a new row in a matrix. The method includes identifying the signal of interest from the matrix, whereby an uncertainty of which frequency bin the signal of interest exists in is eliminated.

According to another embodiment, a method is performed of processing a signal of interest from a compound signal. The method includes generating an array wherein each element of the array is associated with a corresponding frequency bin of a plurality of frequency bins, each frequency bin extending over a portion of a bandwidth of the compound signal and initializing the array to zero. The compound signal is obtained as a digital waveform signal, with sampling rate S samples per second from data storage or from conversion of a physical analog signal received from an analog source or is captured by a physical analog device. For each sample of the digital signal the array is recursively updated by, for each frequency bin, where f is the center frequency of the bin, multiplying the previous value for that bin in the array by r, where r is an exponential decay constant greater than zero and less than 1, and adding the new signal sample multiplied by a real constant and by e^{-i2πnf/S}, where f is a center frequency of the given frequency bin, S is the sampling rate, and n is a current sample number. The method includes saving the updated array as a new row in a matrix. The method includes identifying the signal of interest from the matrix, whereby an uncertainty of which frequency bin the signal of interest exists in is eliminated.

According to an embodiment, a method is performed of processing a signal of interest from a compound signal. The method includes generating a matrix wherein each column is associated with a corresponding frequency bin of a plurality of frequency bins, each frequency bin extending over a portion of a bandwidth of the compound signal and initializing a first row of the matrix to zero. The compound signal is obtained as a digital waveform signal, with sampling rate S samples per second from data storage or from conversion of a physical analog signal received from an analog source or is captured by a physical analog device. The method includes performing a Fourier transform on the digital signal to populate each cell of the matrix with values. The method includes multiplying the value in each cell of the matrix by the complex number e^{-i2πnf/S}, where n corresponds to the n'th sample in the matrix, f is the center frequency of the bin, and S is the sampling rate. The method includes identifying the signal of interest from the matrix, whereby an uncertainty of which frequency bin the signal of interest exists in is eliminated.

According to another exemplary embodiment, another step is added to any of the phase corrected methods above to accurately compute the frequency of a signal. This is done by locating the frequency bins nearest the signal frequency (one above and one below) by inspecting the magnitude of the values in the bins. Then the rate that the phase in each of the two bins is rotating is computed (the one below will be rotating positively, the one above negatively) by inspecting multiple time slices and computing the slope of the phase in rotations (cycles) per second. The implied frequency of the signal is computed by adding the rotational rate to the bin frequency.

In another exemplary embodiment, after using the above method to compute the implied signal frequency using the bin above and the bin below, a best estimate for the actual signal frequency can be made by averaging the two results.

### BRIEF DESCRIPTION OF THE DRAWINGS

Embodiments of the invention will now be described, by way of example only, with reference to the accompanying schematic drawings in which corresponding reference symbols indicating corresponding parts, and in which:

FIG. 1 shows a schematic diagram of a system used to digitally transform an analog input signal, according to an embodiment.

FIG. 2 illustrates the construction of a matrix using a recursive exponential transform (RET), according to an embodiment.

FIG. 3 illustrates an implementation of the recursive exponential transform (RET) to build each cell of the matrix, according to an embodiment.

FIG. 4 illustrates a window, 4 cycles long, of an example sine wave.

FIG. 5 illustrates another window, 4 samples long, of the example sine wave.

FIG. 6 shows an 8 second portion of the complex function of time that a signal is effectively convolved with, according to an embodiment.

FIG. 7 shows, for purposes of comparison, typical graphs of FFT bin amplitude vs. frequency for various windowing functions.

FIG. 8 shows, in an exemplary embodiment, graphs of RET bin amplitude vs. frequency for various exponential decay rates.

FIG. 9 shows a schematic diagram of a system used to digitally transform an analog input signal, according to an embodiment.

FIG. 10 illustrates the construction of a matrix using a digital infinite exponential transform (DIET), according to an embodiment.

FIG. 11 illustrates an implementation of the digital infinite exponential transform (DIET) to build each cell of the matrix, according to an embodiment.

FIG. 12 illustrates a matrix of amplitude outputs using the RET or DIET with a 0.035 db/sec decay constant for an example input signal, according to an embodiment.

FIG. 13 illustrates a matrix of phase output of a DIET on the example input signal, according to an embodiment.

FIG. 14 illustrates a matrix of amplitude outputs of an FFT of length 65,536 for the same input signal.

FIG. 15 illustrates a matrix of phase output of the FFT of length 65,536 for the same input signal.

FIG. 16 illustrates a matrix of amplitude outputs of an FFT of length 524,288 for the same input signal.

FIG. 17 illustrates an example computer system useful for implementing various embodiments.

### DETAILED DESCRIPTION OF THE PREFERRED EMBODIMENTS

The specification discloses one or more embodiments that incorporate the features of the invention. The disclosed embodiment(s) merely exemplify the invention. The scope of the invention is not limited to the disclosed embodiment(s).

The embodiment(s) described, and references in the specification to “one embodiment,” “and embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The following definitions are used herein.

FT: Fourier Transform—an algorithm that computes the amplitudes of the spectrum for a waveform.

DFT: Discrete Fourier Transform—an algorithm that computes the amplitudes of the spectrum for a discrete (digitized) waveform. The DFT output can be a complex number or just the real amplitude. Many of the preferred embodiments of this invention only need the real amplitude. Unless specifically described as complex, all references to DFTs herein are for DFTs with real output.

FFT: Fast Fourier Transform—a fast running DFT method often used synonymously with DFT. DFT and FFT are used interchangeably herein.

STFT: Short Term Fourier Transform—a series of periodic DFTs used to produce a matrix of amplitude (or amplitude and phase) as a function of frequency and time.

DWT: Digital Wavelet Transform—a transform where a “wavelet” is defined over some short period of time and the signal is convolved with wavelets to produce the frequency bins of the transform. Typically, the wavelets are scaled (in time) for the various frequency bins, higher frequencies having proportionately shorter wavelets.

Window: The portion of time used by a Fourier Transform (or equivalent technique). In a DFT the window size (in samples) is known as the length of the DFT. For example, if a signal is digitized with 8000 samples per second, a DFT with a length of 4000 will operate on 4000 samples (one half-second) of data.

Windowing technique: A DFT method whereby the signal values in the window are multiplied by a function so as to reduce the leakage in the DFT.

Leakage: The appearance of signal strength in frequency bins near the correct frequency bin. For example, in an FFT that has frequency bins centered at integer 1 Hz intervals (i.e. 1 Hz, 2 Hz, etc.), a 1000 Hz tone might also yield values in the frequency bins centered at 999 Hz and 1001 Hz.

dB: decibel—logarithmic ratio of measurement used in, for example, acoustics and electronics measurements and calculations.

Time slice: A portion of time.

Frequency bin: A small range of frequencies (e.g. 1702-1704 Hz)

Cell: A unit in a matrix. A cell represents a given frequency bin in a given time slice and contains a complex number, which represents the amplitude and phase of the signal at that given frequency at that given time.

Embodiments herein describe new ways of digitally constructing various frequency slices of an analog input signal using a constructed matrix of values. The described embodiments demonstrate a substantially higher frequency resolution as compared to previous methods (e.g., FFT). These new transforms are identified herein as the recursive exponential transform (RET) and the digital infinite exponential transform (DIET). Generating this matrix involves recursively building each time slice (row) of the matrix from the preceding time slice combined with the new data (signal), according to an embodiment. The basic transform algorithm computes a new row for every sample in the digitized signal. Thus, if the sampling rate is 10,000 samples per second, a time slice would be 0.1 milliseconds.

Each cell in the time slice is computed separately; the RET uses a different recursion formula for each frequency bin. Furthermore, unlike a DFT, the bins do not need to be equally spaced in frequency; each bin frequency may be individually chosen. Entire frequency ranges may be omitted or frequency bins may be tightly clustered in some frequency ranges while sparse in others.

Specifically, the transform does not automatically produce frequency bins up to the Nyquist frequency. Traditionally signals up to the Nyquist frequency (half the sampling rate) are analyzed, and DFTs automatically produce frequency bins up to the Nyquist frequency. However, significant precision is lost at the higher frequencies. Signals at less than half the Nyquist frequency can be more accurately analyzed. The top half of the frequency range normally produced by a DFT is undesirable for high precision analysis. Even more precision is gained if this factor is doubled again and frequencies above a quarter the Nyquist frequency are ignored. In practice, the frequencies of interest are a given. Thus, these modifications imply doubling or quadrupling the sampling rate over what was previously assumed to be adequate.

The RET is fundamentally different from a DFT with an exponential windowing function because of its infinite length. Whereas the frequencies of the bins in a DFT are determined by the window length, an infinite length in the RET would lead to an infinite number of bins. With a RET the number of bins and the bin frequencies may be chosen manually. One can build a RET with only a single bin (at, say, 100 Hz). The method builds each bin individually, so building one bin is no different than building a thousand, except that building a thousand is a thousand different instances of building a single bin.

Furthermore, the infinite length of the RET yields potentially unlimited frequency resolution. Conversely, the frequency resolution of a DFT is defined by the window length, which is limited by the memory capacity of the machine the DFT is implemented on. The bin width in Hz in a DFT equals one divided by the length of the window in seconds. For example, the digital signal on a typical commercial Compact Disc (CD) has a sampling rate of 44,100 samples per second. To compute a DFT with a bin width of 0.1 Hz the DFT would need to be 441,000 samples long. Many popular DFT software packages for computers limit DFTs to 65,536. While specialized software exists that allows longer DFTs, any software on any machine will have a finite limit. The RET has no such limit and frequency resolutions of 0.01 Hz, or 0.001 Hz, or 0.0001 Hz, or less can be achieved by setting a parameter.

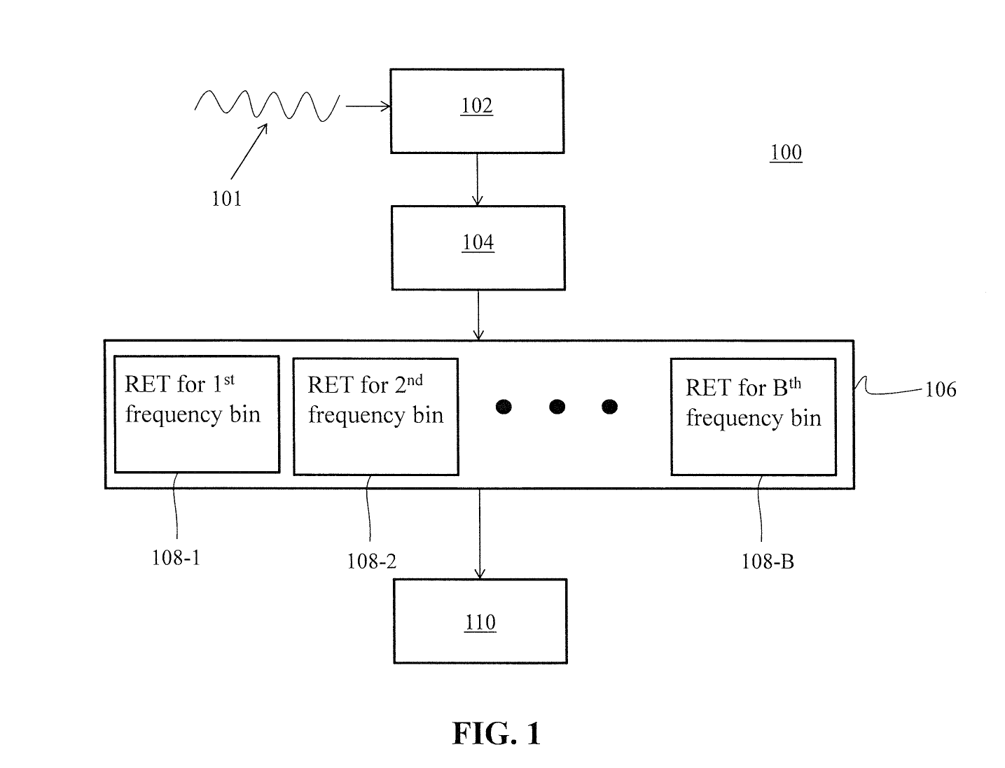

FIG. 1 illustrates an example signal processing system 100, according to an embodiment. Signal processing system 100 includes an analog receiver 102, an analog-to-digital converter (ADC) 104, a processing device 106 and an output device 110.

Analog receiver 102 may include a microphone or any other suitable hardware device designed to receive an electromagnetic signal 101 and transduce it into an electrical signal.

ADC 104 receives the analog electrical signal from analog receiver 102 and converts it into a digital signal. ADC 104 includes the necessary circuits and components to perform the conversion as would be well known to a person skilled in the art.

Processing device 106 may include any number of processors and/or field programmable circuits (such as FPGA) designed to receive the digital signal from ADC 104 and perform various transforms to the signal. Processing device 106 is designed to perform the RET transform on the received digital signal from ADC 104. The signal is split into B number of frequency bins. The number of frequency bins may be manually chosen by a user, set to a default value, or automatically generated by processing device 106.

The number of bins and their spacing is determined by the application. In an exemplary embodiment searching for a signal between 2000 Hz and 2100 Hz, where a frequency resolution of 0.01 Hz is needed, bins could be chosen for 2000, 2000.01, 2000.02, . . . , 2099.99 and 2100 Hz, for a total of 10,001 bins. In another exemplary embodiment performing the same search, bins might initially be chosen at 1 Hz intervals—2000, 2001, 2002, . . . , 2099 and 2100 Hz. However, upon learning, from this initial analysis, the approximate location of the signal or signals of interest (e.g., 2046-2047 Hz), more bins could be added at 0.01 Hz intervals just in that region (e.g., 2046.01, 2046.02 Hz, etc.)

Another exemplary embodiment would search for an airplane black box. The frequency bins would be selected only near the given frequency of the black box “pinger” (37,500 Hz). Due to sample variation, this pinger might actually generate a signal somewhere between 37,400 Hz and 37,600 Hz. Thus, this embodiment might use frequency bins of 37,400, 37,400.001, 37,400.002, . . . , 37,599.999 and 37,600 Hz, for a total of 100,001 bins. Computing such a large number of bins might involve multiple processors or even multiple computers, each processor or computer being assigned a subset of the entire frequency range.

Once the number of frequency bins have been established, processing device 106 performs the RET for each frequency bin 108-1 up to 108-B as illustrated in FIG. 1. The transform is computed recursively for each frequency bin. That is, for a bin b of center frequency f, for sample n in the input signal, the complex value for the corresponding cell is computed from the cell value from sample n−1. Specifically, the formula is:

C_{b,n}=C_{b,n-1}re^{i2πft}+2(1−r)Wₙ

C_{b,0}=0+0i

Where,

C_{b,n} is the cell value (complex) for bin b and time slice n.

t is the length of a time slice (e.g., the time from sample n−1 to sample n). t=1/the sampling rate (t=1/S).

f is the center frequency of the bin b.

Wₙ is the input waveform at the n'th sample.

r is the exponential decay multiplier—the factor each succeeding result is reduced by, per time slice. r is normally close to 1. For a decay of D dB per second, and a sampling rate of S, r is given by:

r=10^{-D/(20*S)}

In an example, for a decay rate of 3 dB per second and a sampling rate of 10,000 samples per second, r would be approximately 0.9999.

In an embodiment, each of bins 108-1 to 108-b are computed individually where the exponential decay rates can be different for different bins. In that case D and r would be written as D_{b} and r_{b} in the above formulas.

The 2(1−r) term in the recursive formula for C_{b,n} acts as a normalization term so that a signal at frequency f will yield a C_{b,n} with an amplitude of A, according to an embodiment. The (1−r) term may be analogous to the normalization used in exponential smoothing. Normalizing the amplitude by multiplying by 2(1−r) is not required in the RET process. For example, FFTs produced using windowing functions do not produce normalized magnitudes.

According to an embodiment, processing device 106 generates a matrix of values with each column being assembled based on using the RET for a particular frequency bin. The matrix may be sent to output device 110, or further processing on the matrix may be performed, such as building a Precision Measuring Matrix (PMM) as described in U.S. Pat. No. 8,620,976, which is incorporated herein by reference in its entirety.

Output device 110 may be a data storage or transmission device or a visualization device having a user interface to visualize an output of the RET process. A visualization device is, for example, a display device or a printing device. Example display devices may include liquid crystal displays, projection monitors, etc. Example printing devices may include toner-based printers, liquid ink-jet printers, inkless printers, etc. Other interim results of the exemplary embodiments may also be provided to output device 110. In an exemplary embodiment, output device 110 may be data storage to store the matrix. In an exemplary embodiment, output device 110 may be a transmission device to send the matrix to another device. These results may then be used by a signal processor or other device to modify the original waveform. In an exemplary embodiment, output device 110 may include both data storage and a visualization device so that the signal processor can be manually adjusted to achieve the desired result.

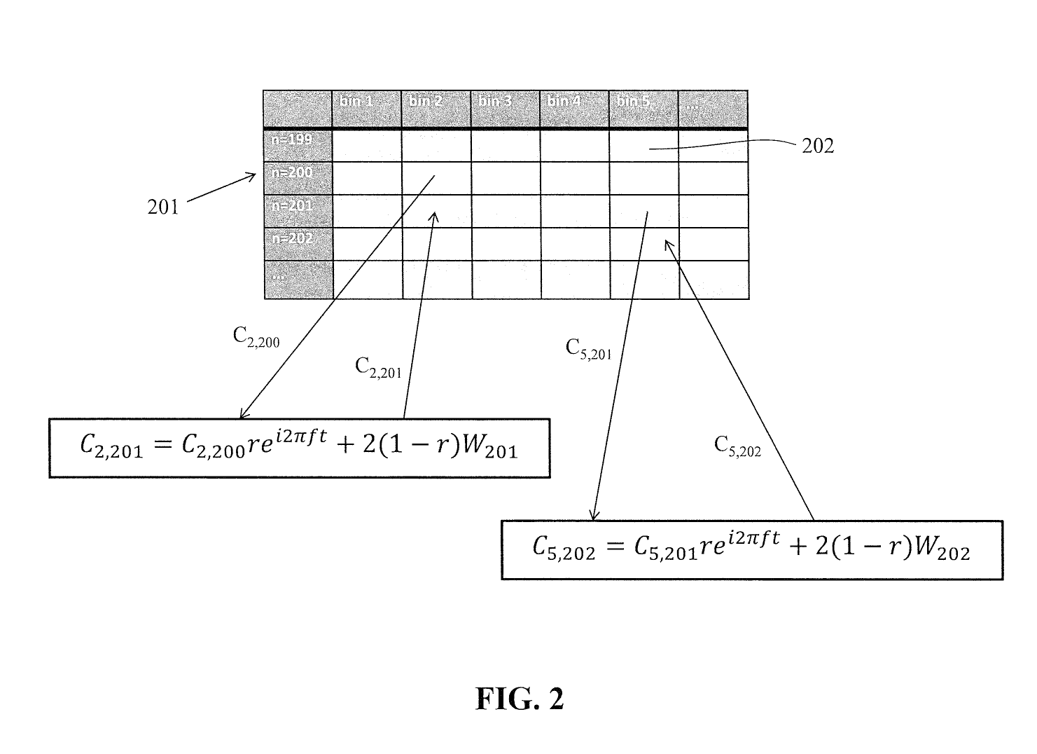

FIG. 2 illustrates an example of building a matrix 201, using the RET described above, according to an embodiment. Matrix 201 includes an array of columns with each column representing a different frequency bin, and an array of rows with each row representing a discrete time sample of the analog input signal, according to an embodiment.

Each cell 202 of matrix 201 is calculated using the RET. In the example illustrated in FIG. 2, the cell at sample 201 of bin 2 (C_{2,201}) is calculated using the value from the previous cell in the same bin ((C_{2,200}). Similarly, the cell at sample 202 of bin 5 (C_{5,202}) is calculated using the value from the previous cell in the same bin ((C_{5,201}).

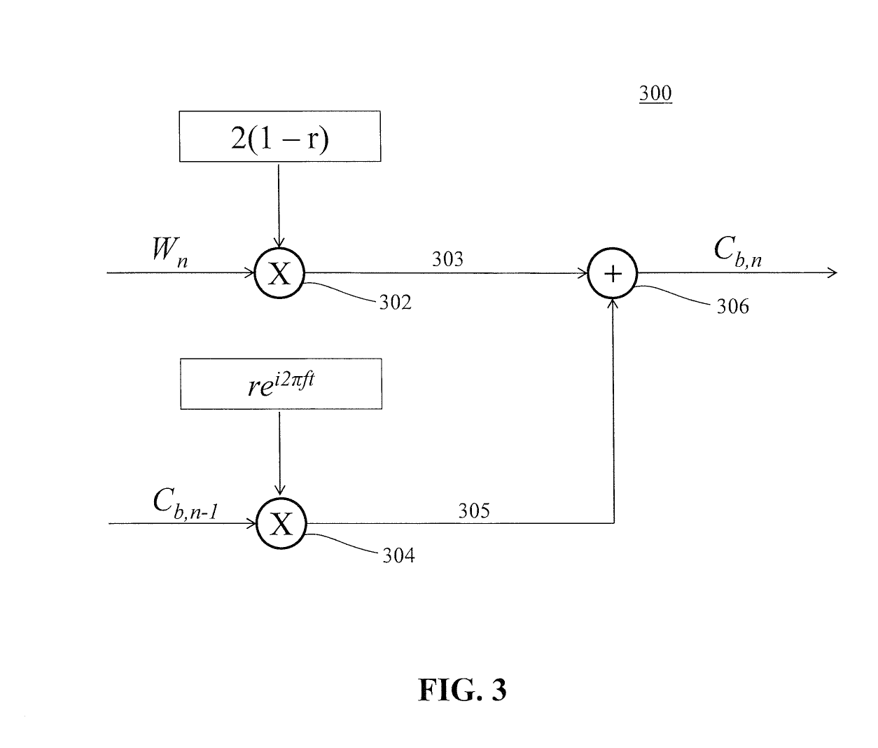

FIG. 3 illustrates a high level implementation of the RET using processing device 106 to generate the value for a given cell (C_{b,n}) of the matrix, according to an embodiment. Processing device 106 includes a first multiplier 302, a second multiplier 304, and an adder 306, according to an embodiment. First multiplier receives the input signal W taken at sample n as a first input and also receives the real constant value 2(1−r) as a second input. These two digital values are multiplied together to generate first output 303.

Second multiplier 304 receives the value of the previous matrix cell C_{b,n-1}, as illustrated in FIG. 2, as a first input and also receives the complex value re^{i2πft} as a second input. These two digital values are multiplied together to generate second output 305.

First output 303 and second output 305 are received as a first and second input to adder 306. The addition of first output 303 and second output 305 by adder 306 generates the final output value C_{b,n}, which is the generated value for the cell at sample n of bin b in the matrix.

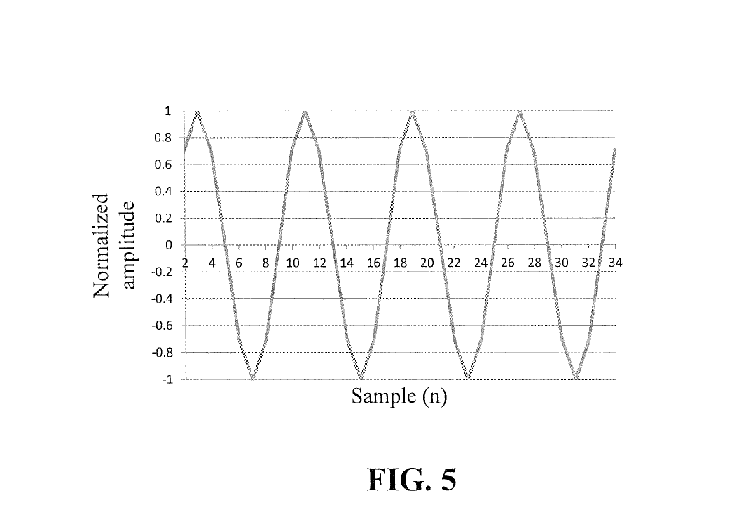

The RET method is equivalent to convolving the input signal with a complex function like the one depicted in FIG. 5, according to an embodiment. In FIG. 5, f is 4 Hz, the sampling rate is 1000, and r is 0.9997. This would be, in an exemplary embodiment, equivalent to how the 4 Hz bin is computed. Note that FIG. 5 only shows the first 8 seconds of the complex function that the signal is effectively convolved with. We do not picture the whole function as it is infinitely long.

This convolution can also be written as an integral, thus defining the transform in general mathematical terms—not just as a digital process.

C(f,T)=∫_{-∞}^{T}W(t)e^{(-R+i2πf)(T-t)}dt

Where, R=D*ln(10)/20≈D*0.11513. In this continuous formation, t represents time (not the width of a time slice), W(t) is a continuous function of time rather than discrete samples, C(f,T) is a function of the continuous variables f and T as opposed to the digital b and n, and C(f,T) is not normalized. R here is shown as a constant but may be a function of frequency—R(f).

This integral representation may be simplified by writing it in terms of a continuous real-time process where “now” is T=0.

C(f)=∫_{-∞}⁰W(t)e^{(R-i2πf)t}dt

Written in this form, the differences from a Fourier Transform become more clear. A Fourier Transform in this notation would be:

C(f)=∫_{-∞}^{∞}W(t)e^{-i2πft}dt

This Fourier Transform is different in that it omits the R constant and integrates from −∞ to ∞ instead of from −∞ to 0.

In the digital transform, all the multiplier terms in the recursive formula can be stored as constants. Thus, a computer algorithm embodiment of the RET runs much faster than an FFT. Even if the total number of frequency bins (N) is the same as with an FFT, the running time is proportional to N, not N log(N) as it is with an FFT.

The RET also has a significant practical advantage in that new frequency bins can be added in a specified frequency region. Thus, for example, if a signal between 100 Hz and 101 Hz is suspected or sought, extra frequency bins may be added in that region (possibly with a slower decay rate, that is r closer to 1) to yield increased frequency selectivity and increased noise rejection. For example, if the original frequency bins were 1 Hz apart (e.g. 99, 100, 101 Hz). New bins might be added every 0.01 Hz apart (100.01, 100.02, etc.) in that region. Thus, the algorithm is capable of “zooming in” to a suspect region. An FFT would have to compute finer spaced bins across the whole frequency range, with a dramatic increase in wasted computer effort.

FIG. 5 shows a complex wavelet that could be used to approximate a bin in a RET, according to an embodiment. The wavelet here is only 8 seconds (8000 milliseconds) long and is for a 4 Hz frequency bin. The sampling rate used in this example is 1000 samples per second and the r is 0.9997

Both the DWT and the DFT involve taking a finite period of time and convolving the input signal over that time period with a function over that same time period. Usually an envelope (or windowing function) is also applied to that time period. In a DFT, this function is thought of as modulating the input signal. Thus, the same windowing function is applied to all bins. The DWT usually uses a different wavelet for each bin (typically scaling the wavelet so that even the length varies) and thus (for those wavelets that are modulated sine and cosine waves) the windowing function is thought of as applying to the sine and cosine waves that the signal is convolved with. Though the speed enhancements of the FFT are forfeited by this, DWTs typically gain speed by reducing the length of the wavelets and the number of bins at higher frequencies. However, the RET is fundamentally different from both the DWT and the DFT because it is infinite.

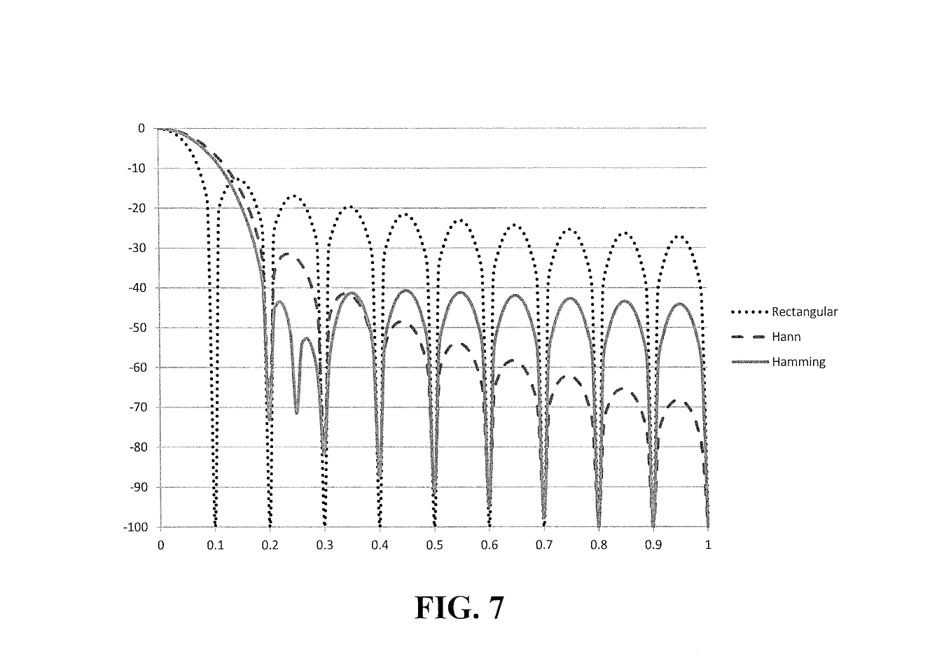

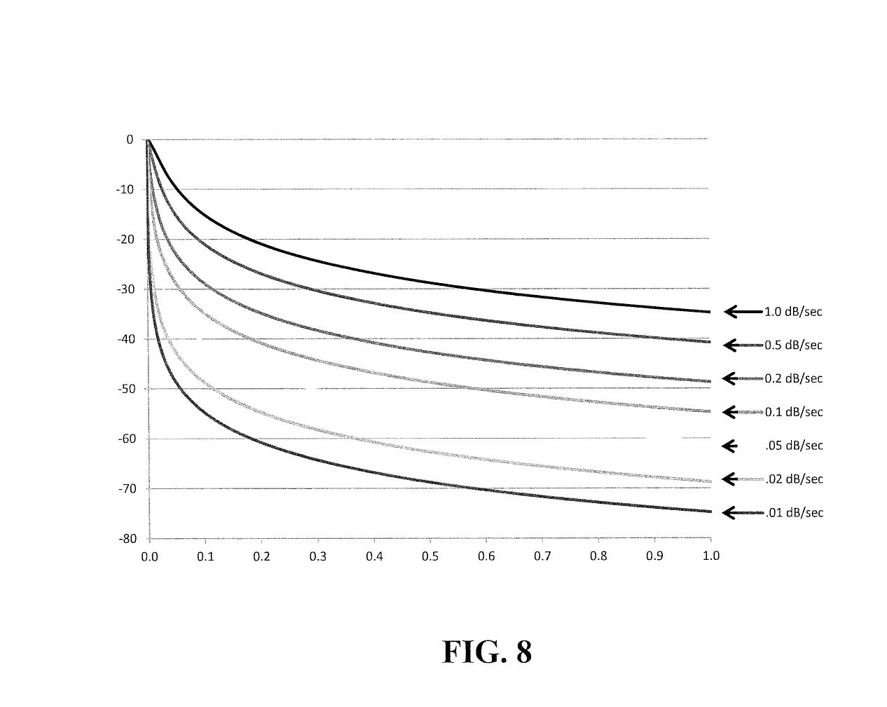

FIGS. 7 and 8 show the dramatic difference between the frequency response of a RET and a DFT.

FIG. 7 shows the frequency response of a DFT using various windowing functions. The normalized frequency of the horizontal axis is often labeled in bins. Here, the FFT frequency bins are 0.1 Hz each, meaning the FFT is 10 seconds long. If the sampling rate is 4096, the FFT window length would need to be 40,960 samples. The plots in FIG. 7 could be for any frequency bin and would give the same result. For this discussion, assume they are for the 1000 Hz bin.

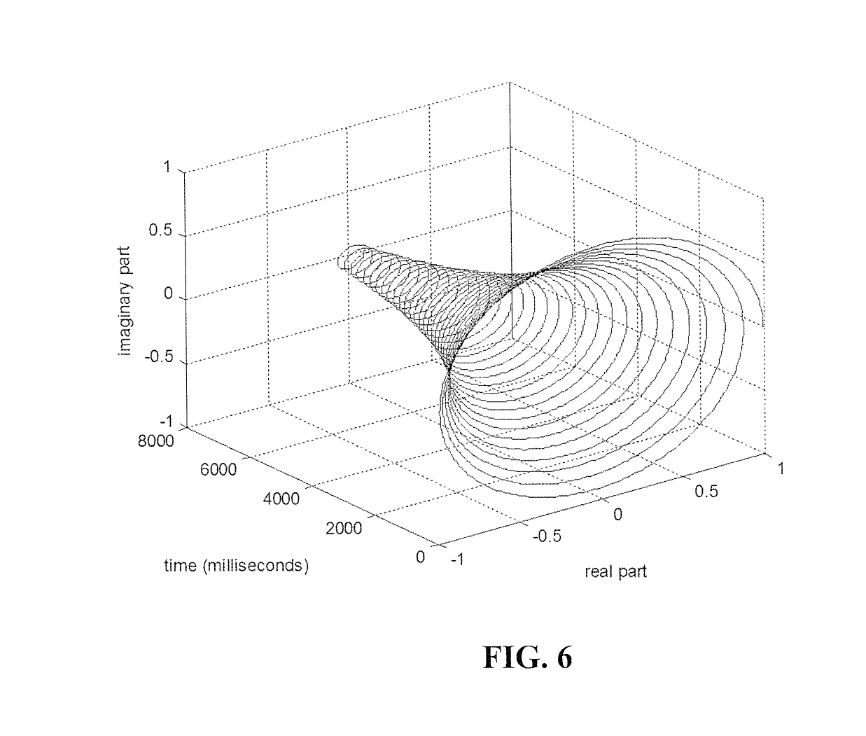

If a 1000 Hz tone is input to the DFT, the output will be maximized. FIG. 6 normalizes this to 0 dB. However, if a tone not equal to 1000 Hz is input, the output will be lower. To generate FIG. 6, start with a 1000 Hz tone and then let the tone rise, while recording the amplitude of the 1000 Hz bin in the DFT output.

For the dotted curve (for a rectangular window, sometimes called no window) we see that as the input tone climbs from 1000 Hz, the output falls until at 1000.1 Hz (exactly one bin away, as the bins are 0.1 Hz) the output vanishes. But as the frequency moves further away from 1000 Hz, the output rises again, then falls, vanishing again at 1000.2 Hz (two bins away). This bouncing ball frequency response repeats indefinitely, though at diminishing magnitude.

Looking at the dashed line marked ‘Hann’ one can see that the attenuation of each lobe increases as the number of bins from the start frequency increases. However the nonlinearity and number of the lobes is an unavoidable feature of any DFT, regardless of the window type used. This renders any amplitude information in the array uncertain, and thus of limited use since searched for frequencies of interest could be found in any number of bins. This uncertainty makes it very difficult to select out the signal of interest from a compound signal.

This response to frequencies other than the correct bin frequency is called “spectral leakage” and is highly undesirable. The traditional approach to this problem is to use a windowing function on the DFT. FIG. 7 shows the behavior of some of the more popular windowing functions. Unfortunately, the performance of these windowing functions involves a tradeoff between the leakage for signals close to the bin frequency and the leakage for signals farther away (seen as a “bouncing ball” effect in the output).

FIG. 8 shows the frequency response of a RET, for various exponential decay rates (expressed in dB per second), according to some embodiments. The RET yields dramatically different behavior than the DFT. The bouncing ball effect is completely eliminated, resulting in an elimination of the uncertainty that exists when using previously known transform methods. Also, the frequency response can be made much narrower, allowing previously undetectable signals to be isolated and measured. Since, unlike a DFT, the frequency bins in a RET are unrestricted, the frequency axis in FIG. 8 is in Hz. This level of frequency selectivity is not possible to achieve for DFTs except when using very low sampling rates, which are only useful for analyzing very low frequencies. For example, marine applications sometimes use very low sampling rates for analyzing sounds in the ocean. This limits the frequency range to only very low frequencies.

All the curves in FIG. 8 are similar except for a frequency scaling factor. The widths of the curves are proportional to the decay rates. Thus the 1.0 dB/sec curve crosses the −20 dB line at twice the frequency as does the 0.5 dB/sec curve and at ten times the frequency that the 0.1 dB/sec curve crosses it. This is in accordance with the solution for the differential equation for a damped harmonic oscillator, according to an embodiment.

The RET process can be enhanced by reconsidering the meaning of phase and changing how phase is computed in the transform. This permits even further improved frequency measurement.

Because FFT output is complex, it has magnitude and phase. Phase is important to generating an inverse transform, but is otherwise usually ignored—while the magnitude tends to be studied extensively. When using typical FFT windowing functions, the phase isn't visible in a useful way. However, in a few special cases, phase can be seen.

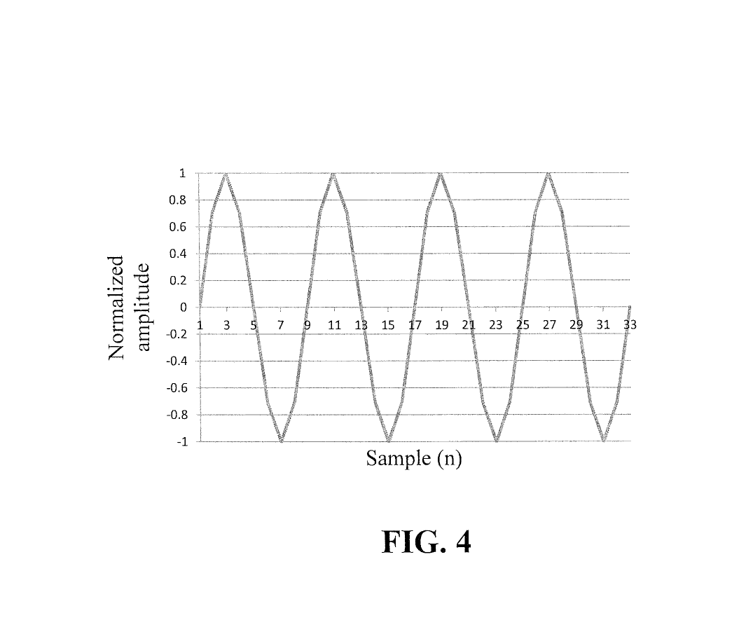

Consider a single sine wave transformed using an FFT with no windowing function (i.e. a rectangular window). Furthermore, let the window length be an exact multiple of the wavelength of the sine wave. For example, consider a sine wave at 100 Hz, the sampling rate 800 samples per second, and the window length 32 samples (0.04 seconds). Thus, the FFT window will contain exactly 4 cycles of the sine wave. Suppose further that an FFT is computed for a window where the 4 complete cycles looks like 4 cycles of a sine wave (as opposed to, say, a cosine wave). That is, it starts at 0, then rises up, etc. until it completes 4 cycles, rising to 0 at the end. This is illustrated in FIG. 4.

This FFT produces frequency bins spaced 25 Hz apart—at 0 Hz, 25, 50, 75, 100, 125, etc. The amplitude in every bin except the 100 Hz bin will be zero (and the phase will be undefined—typically set to zero by convention). For the 100 Hz bin, the amplitude will be the amplitude of the original input signal and the phase will be −90°. This is a result of Euler's formula.

e^{iθ}=cos(θ)+i sin(θ)

Because of Euler's formula, it is the cosine that is considered “real” and thus has zero phase. Since cos(θ)=sin(θ+90°), it is consistent that the sine wave would be labeled as having a phase of −90°. However, the phase changes every time a new FFT is performed. In this example, if a new FFT is performed one sample later, the FFT window is as shown in FIG. 5. The magnitudes are all the same as before but now the phase in the 100 Hz bin is −45°. The phase is consistently rotating forward at 100 Hz.

According to an embodiment, the phase in a bin (relative to a sine wave at the bin frequency) can be “frozen” by multiplying the value in each cell by e⁻ⁱ²^{_{π}}^{fn/S}, where f is the center frequency of the bin and n is the sample indexing the FFT. This correction method may be applied to the RET, DWT, and DFT. By freezing the phase using the above formula, the interpolation of specific frequencies can be done using phase. The phase correction may be applied to the cells in a matrix and then the interpolation done, or the phase correction can be incorporated into the interpolation itself. The interpolated frequency result (and the improvement over the accuracy of conventional methods) will be the same either way.

Once the phase of a signal at the bin frequency does not move, then any phase movement is caused by the difference between the signal frequency and the bin frequency. For example, when using bins at 100 Hz and 101 Hz, a sine wave at 100.1 Hz will show up in the 100 Hz bin, advancing in phase at 0.1 revolutions per second (0.045° per sample in our 800 samples per second example). The 101 Hz bin will show the phase retarding at 0.9 revolutions per second (0.405° per sample in our 800 samples per second example). Thus, the frequency of a tone may be interpolated from the phase rotations in the adjacent bins.

The implied frequency of the signal is the bin frequency plus the phase rotation in revolutions per second (degrees per second divided by 360), according to an embodiment. In the case of above of the 101 Hz bin retarding at 0.9 revolutions per second, retarding phase is negative rotations and the implied frequency is 101+(−0.9) Hz.

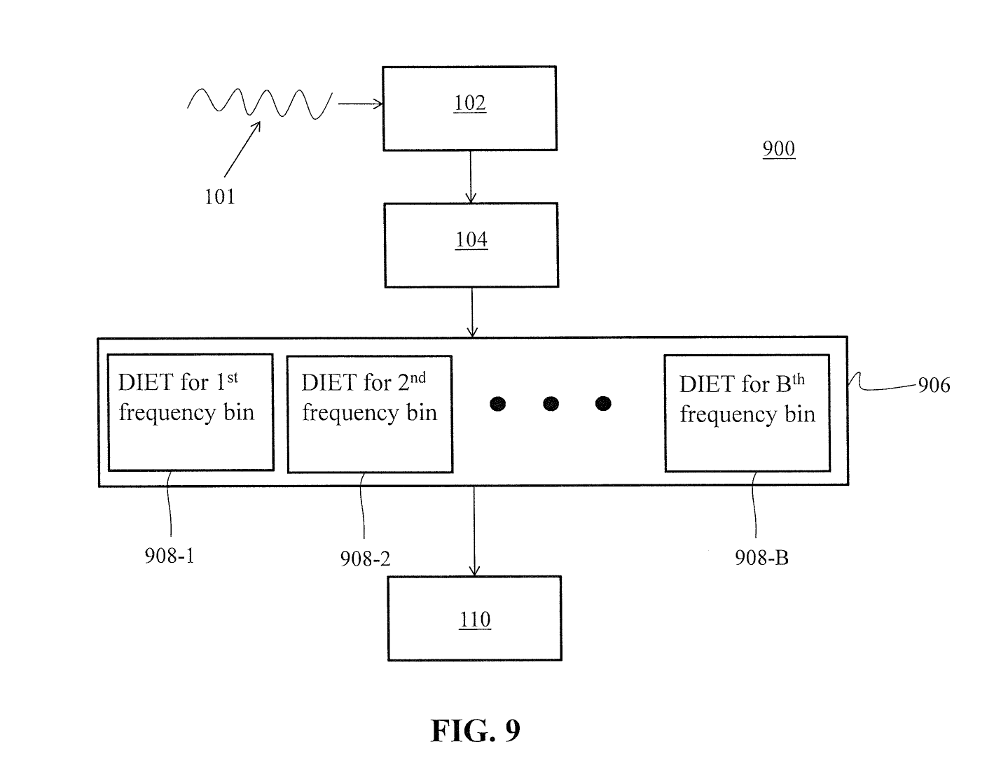

FIG. 9 illustrates an example signal processing system 900, according to an embodiment. Signal processing system 900 includes an analog receiver 102, an analog-to-digital converter (ADC) 104, a processing device 906 and an output device 110. Each of analog receiver 102, ADC 104, and output device 110 may work in a similar way as discussed above with reference to FIG. 1. Processing device 906 of signal processing system 900 is configured to perform the DIET on a received signal, rather than the RET as discussed in more detail below.

Processing device 906 may include any number of processors and/or field programmable circuits (such as FPGA) designed to receive the digital signal from ADC 104 and perform various transforms to the signal. Signal processing system 900 is designed to perform the DIET transform on the received signal. The signal is split into B number of frequency bins. The number of frequency bins may be manually chosen by a user, set to a default value, or automatically generated by processing device 906.

Once the number of frequency bins have been established, processing device 906 performs the DIET for each frequency bin 908-1 up to 908-B as illustrated in FIG. 9. The transform is computed recursively for each frequency bin. That is, for a bin b of center frequency f, for sample n in the input signal, the complex value for the corresponding cell is computed from the cell value from sample n−1. Specifically, the DIET formula is:

C_{b,n}=C_{b,n-1}r+2(1−r)e^{-i2πnft}Wₙ

Other than the change in the formula for Cₙ, the process for producing a DIET is substantially identical to the process for producing a RET.

According to an embodiment, processing device 106 generates a matrix of values with each column being assembled based on using the DIET for a particular frequency bin. The matrix may be sent to output device 110, or further processing on the matrix may be performed to use the phase information to precisely compute frequencies of interest.

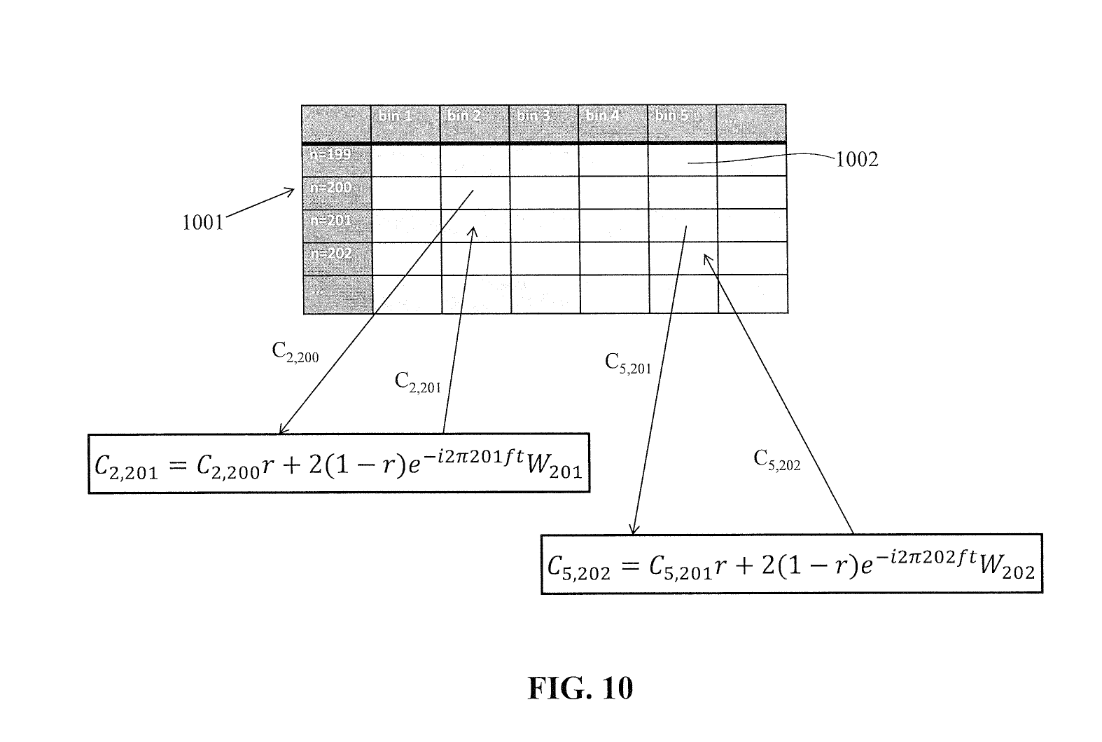

FIG. 10 illustrates an example of building a matrix 1001, using the DIET described above, according to an embodiment. Matrix 1001 includes an array of columns with each column representing a different frequency bin, and an array of rows with each row representing a discrete time sample of the analog input signal, according to an embodiment.

Each cell 1002 of matrix 1001 is calculated using the DIET. In the example illustrated in FIG. 10, the cell at sample 201 of bin 2 (C_{2,201}) is calculated using the value from the previous cell in the same bin ((C_{2,200}). Similarly, the cell at sample 202 of bin 5 (C_{5,202}) is calculated using the value from the previous cell in the same bin ((C_{5,201}). The process of building matrix 1001 using the DIET is the same as the process for building matrix 201 using the RET as illustrated in FIG. 2.

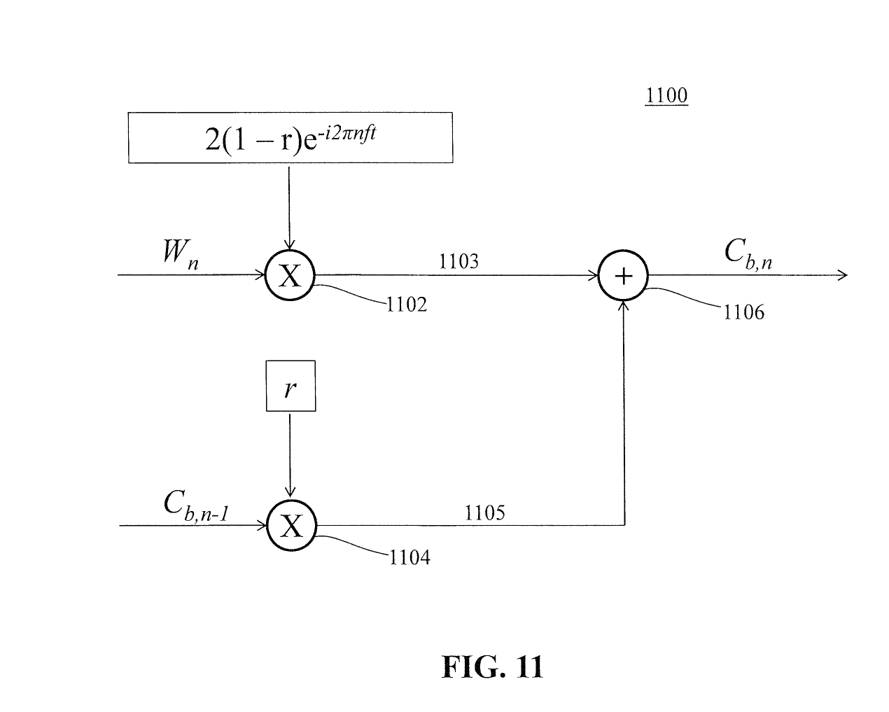

FIG. 11 illustrates a high level implementation of the DIET using processing device 906 to generate the value for a given cell (C_{b,n}) of the matrix, according to an embodiment. Processing device 906 includes a first multiplier 1102, a second multiplier 1104, and an adder 1106, according to an embodiment. First multiplier receives the input signal W taken at sample n as a first input and also receives the complex value 2(1−r)e^{i2πnft} as a second input. These two digital values are multiplied together to generate first output 1103.

Second multiplier 1104 receives the value of the previous matrix cell C_{b,n-1}, as illustrated in FIG. 10, as a first input and also receives the constant value r as a second input. These two digital values are multiplied together to generate second output 1105.

First output 1103 and second output 1105 are received as a first and second input to adder 1106. The addition of first output 1103 and second output 1105 by adder 1106 generates the final output value C_{b,n}, which is the generated value for the cell at sample n of bin b in the matrix.

The recursive transforms used in the DIET technique, by virtue of their infinite length, do not generate the unpredictable (and large) leakage that DFTs do.

Each bin in a DIET (or RET) has a frequency response envelope like the frequency response of a resonant (RLC) circuit. A signal at the frequency of one bin may generate values in nearby bins but the leakage can be made arbitrarily small by making r closer to 1 (analogous to increasing the Q of an RLC circuit). Thus, a sine wave does not generate any results in bins other than the bins at its frequency or the two that surround it.

The impact on the phase of nearby bins is mitigated by the reduced strength of the leakage. The phase can wobble as a result of leakage, but not rotate. Thus, measurements of the total rotation over a period of time are not greatly impacted. This allows for precise frequency interpolation to be done based solely on phase. Thus, the DIET technique achieves significantly greater precision in measuring specific frequencies present in compound waveforms.

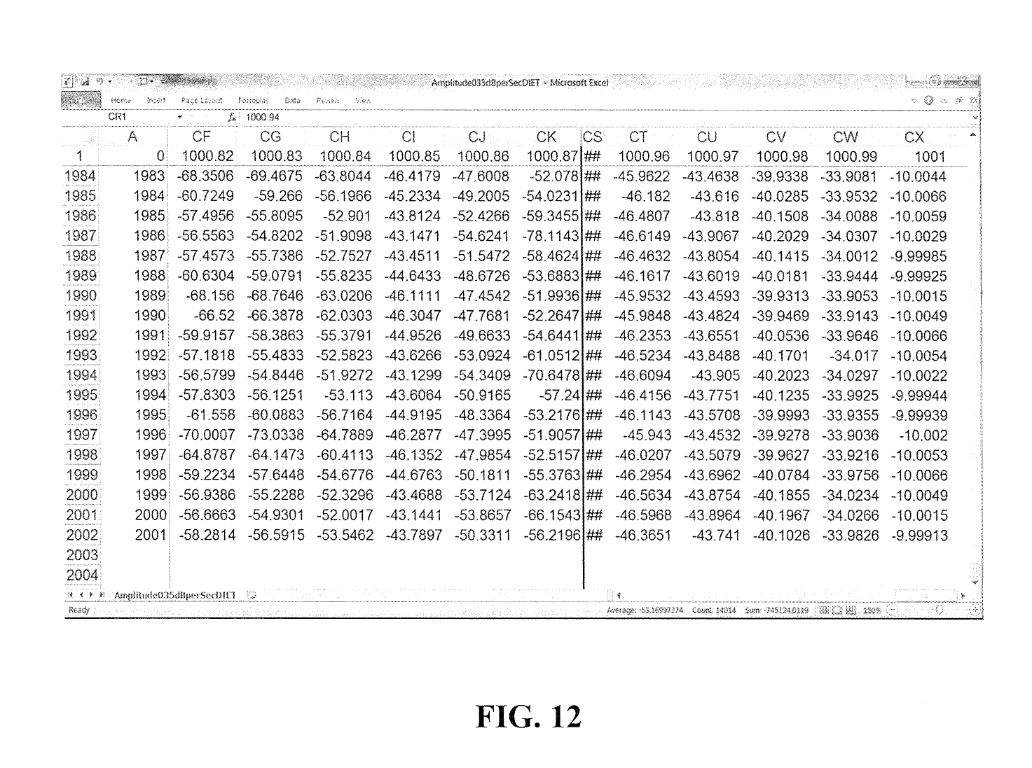

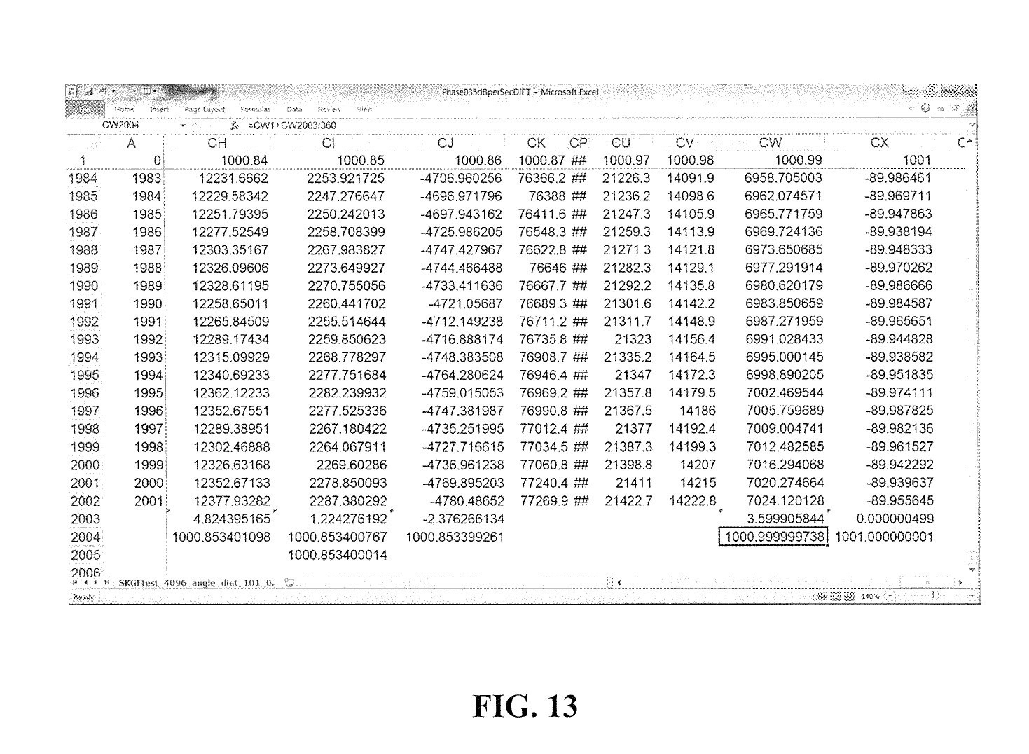

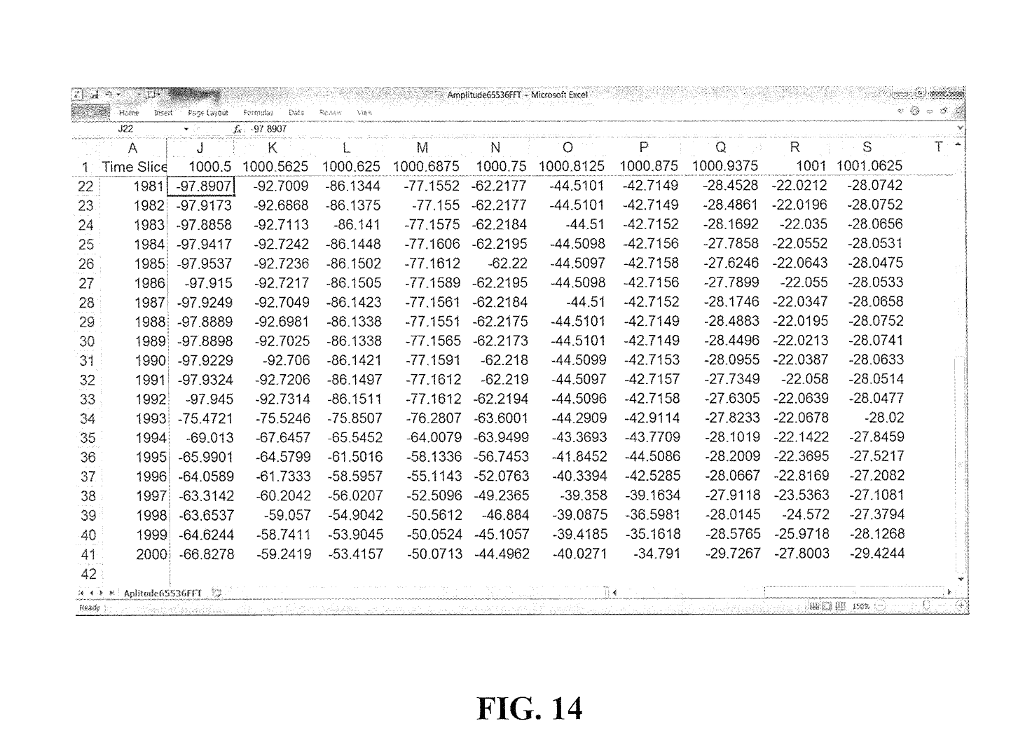

FIGS. 12 and 13 illustrate example matrix outputs when using various transform methods on an input signal, according to embodiments described herein. FIGS. 14-16 illustrate example matrix outputs when using a conventional FFT method on the same input signal. In these figures, the time slice is set to one second. Each row in the matrix represents the signal condition at a time one second later than that of the previous row.

FIG. 12 shows an example matrix of amplitude outputs of a RET (or DIET) with a 0.035 db/sec decay constant, according to an embodiment. In this example, three constant sine waves were input: one at 1000 Hz, one at 1001 HZ and one in between at 1000.8435 Hz. The 1000 Hz and 1001 Hz sine waves have amplitudes of −10 dB. The 1000.8435 Hz is deliberately made difficult to find by giving it an amplitude of only −30 dB (20 dB below the other two signals). In this example, the bins are chosen at 0.01 Hz intervals. The sampling rate is 4096 samples per second. It can be seen that the amplitude is higher in the bins near 1000.8534 Hz. The two highest amplitude bins (sufficiently away from 1000 Hz and 1001 Hz) are the bins just above and below 1000.8534 Hz (the input sine wave between 1000 Hz and 1001 Hz.)

FIG. 13 shows the associated phase output of a DIET and the formulas for computing the frequency of a signal, according to an embodiment. There is a slow rotation of phase in bins near the signal of interest. The rate of rotation can be used to compute the frequency. Note that the phase in the 1000.99 Hz bins is advancing by 3.6 degrees per time slice. That is a rotational rate of 0.01 Hz. This is because the 1000.99 Hz bin is 0.01 Hz “slower” than the 1001 Hz sine wave. The signal is “gaining” on the bin by 0.01 cycles (3.6 degrees) per second. We can compute the implied frequency of the signal this bin is being influenced by, by adding the rotational rate to the bin's frequency. Thus we get 1000.99+3.6/360=1001 Hz.

We may use the same formula in the bins near the signal of interest at 1000.8435 Hz. The 1000.84 Hz bin sees a signal gaining on it by 1.22427 degrees per second, which works out to 0.003400767 Hz. Adding that to the 1000.85 Hz bin frequency yields an implied frequency of 1000.853400767 Hz.

Similarly, the 1000.86 Hz bin is losing phase at a rate of 2.376266 degrees per second, which works out to an implied frequency of 1000.853399261. Averaging the two, we get an implied frequency of 1000.843500014 Hz, only 14 billionths of a Hz off.

FIG. 14 shows the amplitude output of an FFT of length 65,536 for the same input signal. Since 65,536 is 16 times 4096, the frequency bins are at 1/16^{th} Hz intervals. There is no observed increase in the amplitude in the bins around the signal of interest at 1000.8534 Hz when using the FFT.

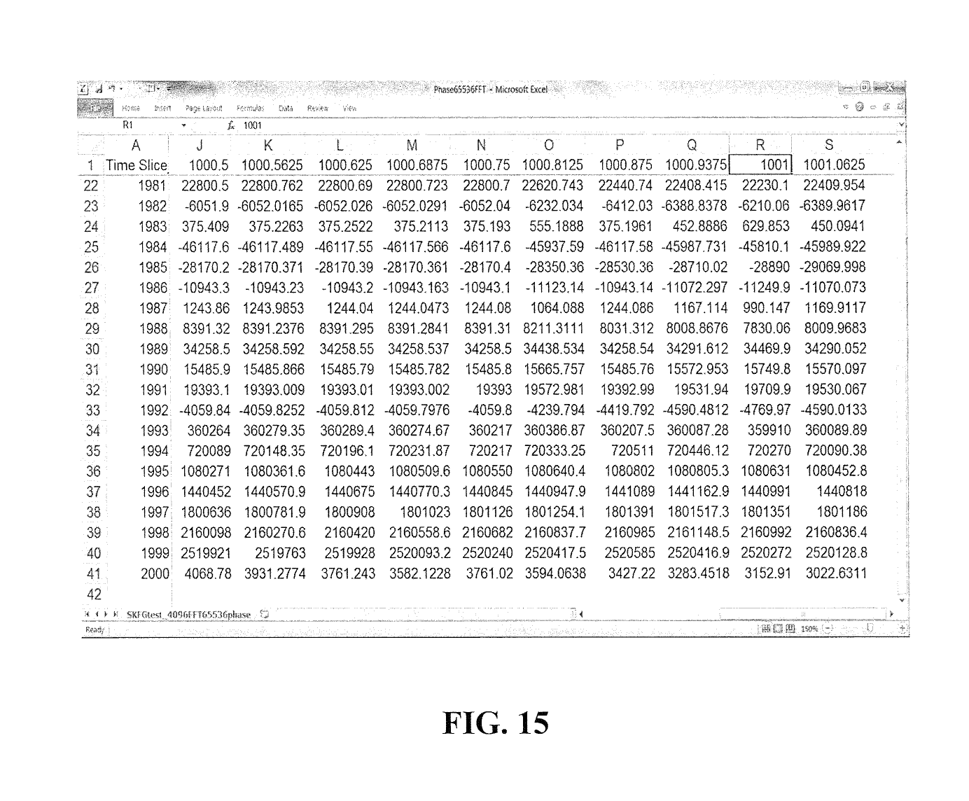

FIG. 15 shows the phase output of the FFT of length 65,536. Unlike the phase output illustrated in FIG. 13 for the DIET technique, the phase here doesn't rotate, but changes constantly. This makes using the phase to calculate the frequency nearly impossible.

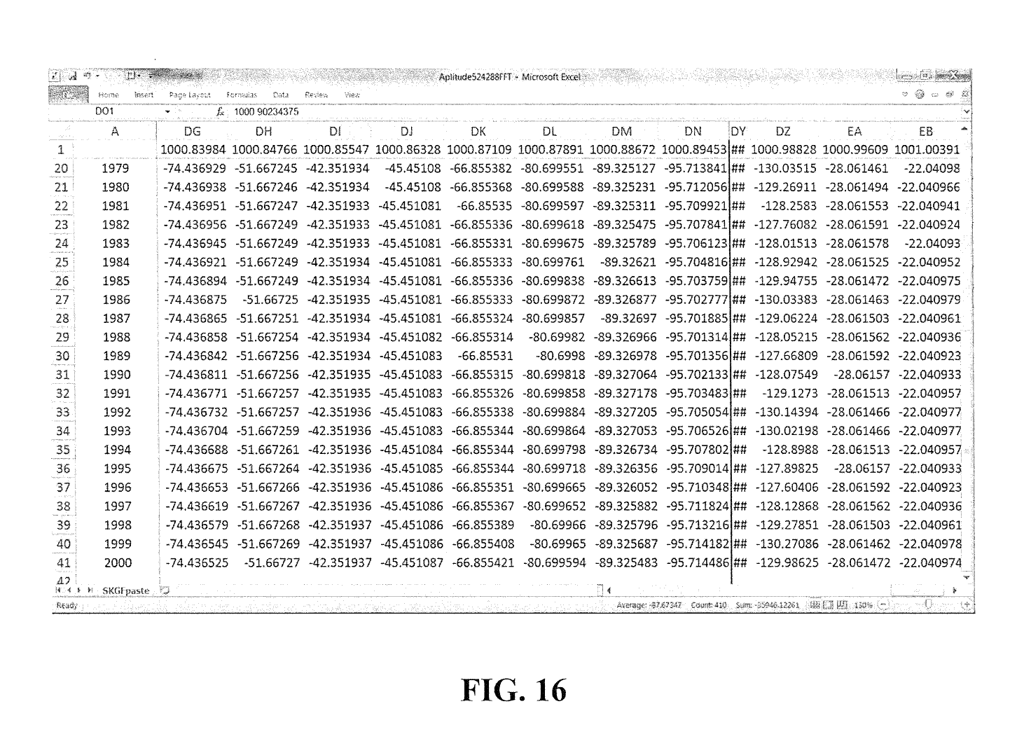

FIG. 16 shows the amplitude output from an FFT of length 524,288 (8 times as long as 65,536). This long FFT has frequency bins at 1/128^{th} Hz intervals. This is sufficiently long to resolve the three sine waves but not as accurately as using the RET or DIET techniques.

There is a noticeable increase in the amplitude near 1000.8534 Hz. The largest amplitude is −42.342 dB in the 1000.85547 Hz bin. The second largest amplitude is −45.451 dB in the 1000.86328 Hz bin. But the frequency of the signal of interest (1000.8534 Hz) is not between these two bins. The stronger signal at 1001 Hz is biasing the results and is throwing the amplitude based frequency calculation off. This highlights the problem with using FFT (even with a large number of samples) to identify specific frequencies within a compound signal.

Conversely, the frequency calculation in the 1000.84 Hz bin from FIG. 13 (using the DIET technique) estimates the signal frequency to within 1098 billionths of a Hz. The DIET technique is able to identify this signal of interest even though the 1000.84 Hz bin is not directly adjacent to the 1000.8534 Hz signal (and its phase rotation exceeds 3.6 degrees per second).

The invention may be embodied by hardware, software on a digital computer machine, or a combination thereof. It may run on a single processor with a single core, a single processor with multiple cores, or multiple processors with single or multiple cores. The invention may be embodied using general or specialized digital signal processor chips. The invention may be embodied in dedicated hardware. The invention may be embodied on one or more circuit boards comprising, for example, digital signal processor chips, to be mounted in a computer or other device.

In an exemplary embodiment, the matrix data structure may be replaced by other data structures that can logically serve the same function. These data structures may be made up of fields. These data structures may include, but are not limited to, for example, a sparse matrix, a linked list or queue, etc. For example, the identified maximum cells may be represented by a sparse matrix, an identified chain of cells may be represented by a linked list, etc.

Some exemplary embodiments may be implemented using parallel computing hardware. The main memory of the parallel computer may be either shared memory (shared between all processing elements in a single address space), or distributed memory (in which each processing element has its own local address space).

The invention has a wide range of applications, including, but not limited to, for example, signal time-variance analysis including audio, audio spectrum analysis, image analysis, and analysis of signals that contain information or characteristics or properties of something corporeal in an applicable industry in any frequency range, radar, sonar, speech recognition, etc.

The information developed by the invention may be used to provide new or improved inputs to other signal processors, analysis devices, algorithms, systems, and organizations. Signals that were previously hidden by stronger signals can now be measured. For example, RETs could be used in the construction of a Precision Measuring Matrix (PMM).

The examples and embodiments described herein are non-limiting examples. The invention is described in detail with respect to exemplary embodiments, and to those skilled in the art will now be apparent from the foregoing that changes and modifications may be made without departing from the invention in its broader aspects, and the invention, therefore, as defined in the claims is intended to cover all such changes and modifications as fall within the true spirit of the invention.

Exemplary embodiments of the invention can be used to accurately measure sound components even when the sound components are part of a compound waveform containing a mixture of sounds. Exemplary embodiments of the invention may also be used, for example, for compound waveforms containing sounds even when the sounds come in short or long duration bursts and/or are changing in pitch and/or in amplitude.

Note that the infinite length of the RET and DIET transforms makes then uniquely useful for applications where extreme frequency selectivity are needed. For example, finding airplane “black boxes” in the ocean is difficult because of the noisy environment. However, these new transforms easily allow 3 db widths of 0.001 Hz or less. The frequency selectivity can be unlimited, being only a function of r in the formulas above, according to an embodiment. The black boxes emit a pulse of 37.5 kHz for 10 milliseconds once every second (i.e., 10 milliseconds of 37.5 kHz, then 990 milliseconds of silence, repeatedly). Given the high sampling rate required to digitize a frequency this high, an FFT long enough to produce a bin size of less than one Hz would be challenging. At such high frequencies, FFT bin sizes on the order of 0.001 Hz are virtually unheard of. Even in that case, a practical windowing function would give a much greater 3 dB width. The extreme frequency selectivity of the RET and DIET techniques vastly raises the effective signal-to-noise ratio of the detector. This can increase the range of the detector (only a few miles using current technology) by multiple orders of magnitude.

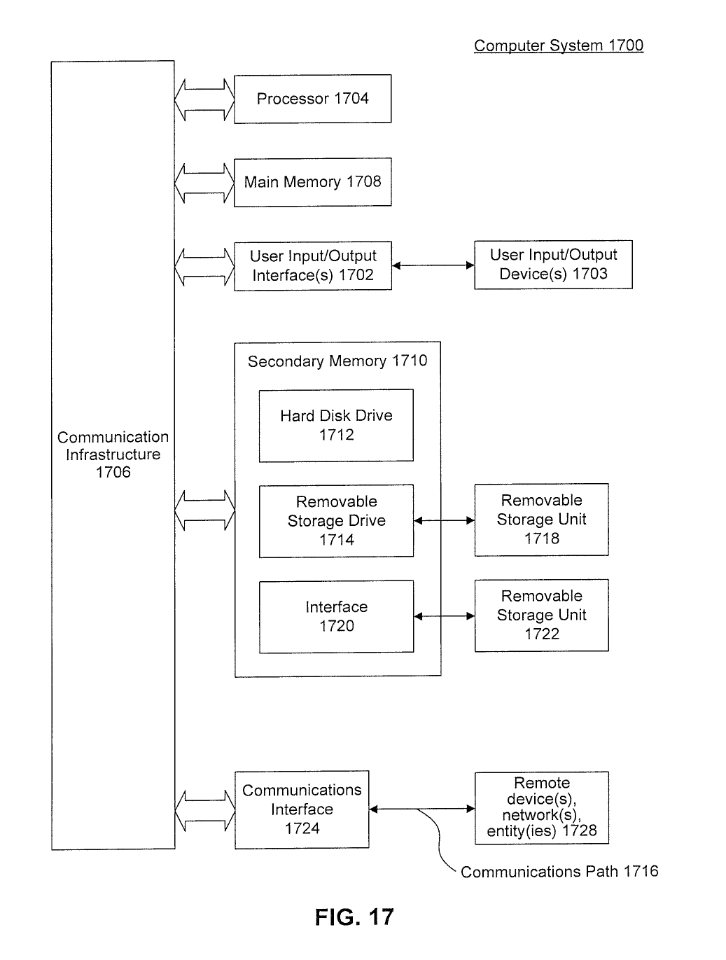

The digital transform embodiments described thus far can be implemented, for example, using one or more well-known computer systems, such as computer system 1700 shown in FIG. 17. In an embodiment, computer system 1700 may be an example of processing device 106 illustrated in FIG. 1 or processing device 906 illustrated in FIG. 9.

Computer system 1700 includes one or more processors (also called central processing units, or CPUs), such as a processor 1704. Processor 1704 is connected to a communication infrastructure or bus 1706. In one embodiment, processor 1704 represents a field programmable gate array (FPGA). In another example, processor 1704 is a digital signal processor (DSP).

One or more processors 1704 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1700 also includes user input/output device(s) 1703, such as monitors, keyboards, pointing devices, etc., which communicate with communication infrastructure 1706 through user input/output interface(s) 1702.

Computer system 1700 also includes a main or primary memory 1708, such as random access memory (RAM). Main memory 1708 may include one or more levels of cache. Main memory 1708 has stored therein control logic (i.e., computer software) and/or data.

Computer system 1700 may also include one or more secondary storage devices or memory 1710. Secondary memory 1710 may include, for example, a hard disk drive 1712 and/or a removable storage device or drive 1714. Removable storage drive 1714 may be a floppy disk drive, a magnetic tape drive, a compact disc drive, an optical storage device, tape backup device, and/or any other storage device/drive.

Removable storage drive 1714 may interact with a removable storage unit 1718. Removable storage unit 1718 includes a computer usable or readable storage device having stored thereon computer software (control logic) and/or data. Removable storage unit 1718 may be a floppy disk, magnetic tape, compact disc, Digital Versatile Disc (DVD), optical storage disk, and/any other computer data storage device. Removable storage drive 1714 reads from and/or writes to removable storage unit 1718 in a well-known manner.

Secondary memory 1710 may include other means, instrumentalities, or approaches for allowing computer programs and/or other instructions and/or data to be accessed by computer system 1700. Such means, instrumentalities or other approaches may include, for example, a removable storage unit 1722 and an interface 1720. Examples of the removable storage unit 1722 and the interface 1720 may include a program cartridge and cartridge interface (such as that found in video game devices), a removable memory chip (such as an EPROM or PROM) and associated socket, a memory stick and universal serial bus (USB) port, a memory card and associated memory card slot, and/or any other removable storage unit and associated interface.

Computer system 1700 may further include a communication or network interface 1724. Communication interface 1724 enables computer system 1700 to communicate and interact with any combination of remote devices, remote networks, remote entities, etc. (individually and collectively referenced by reference number 1728). For example, communication interface 1724 may allow computer system 1700 to communicate with remote devices 1728 over communications path 1726, which may be wired and/or wireless, and which may include any combination of local area networks (LANs), wide area networks (WANs), the Internet, etc. Control logic and/or data may be transmitted to and from computer system 1700 via communication path 1726.

In an embodiment, a tangible apparatus or article of manufacture comprising a tangible computer useable or readable medium having control logic (software) stored thereon is also referred to herein as a computer program product or program storage device. This includes, but is not limited to, computer system 1700, main memory 1708, secondary memory 1710, and removable storage units 1718 and 1722, as well as tangible articles of manufacture embodying any combination of the foregoing. Such control logic, when executed by one or more data processing devices (such as computer system 1700), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 17. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, performed by one or more processing devices, of processing a signal of interest from a compound signal, the method comprising:
generating a matrix wherein each column is associated with a corresponding frequency bin of a plurality of frequency bins, each frequency bin extending over a portion of a bandwidth of the compound signal;
initializing a first row of the matrix to zero;
obtaining the compound signal in the form of a digital signal, with sampling rate S samples per second, from data storage or from conversion of a physical analog signal received from an analog source or captured by a physical analog device;
for each sample of the digital signal, recursively computing, using a processing device, a new entry for the matrix, wherein the computing comprises, for each frequency bin:
multiplying a previous row entry of a given frequency bin by r*e^{i2πf/S}, where r is a constant greater than zero and less than 1, f is a center frequency of the given frequency bin, and S is the sampling rate, and
adding a current digital signal sample multiplied by a real constant; and
at least one of storing the matrix, transmitting the matrix, displaying the matrix, and identifying the signal of interest from the matrix, whereby an uncertainty of which frequency bin the signal of interest exists in is eliminated.

2. The method of claim 1, wherein the real constant is 2*(1−r).

3. The method of claim 1, further comprising multiplying the value in each cell of the matrix by e^{-i2πnft}.

4. The method of claim 3, further comprising:
locating the frequency bins nearest to the signal of interest;
computing the rate that the phase in each of the two nearest frequency bins is rotating by inspecting multiple samples in each of the two nearest frequency bins;
computing an implied frequency of the signal of interest by adding the rotational rates to the frequencies of each of the two nearest frequency bins; and
storing, transmitting, or displaying the resulting implied signal frequency.

5. The method of claim 1, wherein the compound signal includes a plurality of other signals in addition to the signal of interest.

6. The method of claim 5, wherein the signal of interest has an amplitude that is at least 20 dB less than at least two of the plurality of other signals.

7. A method, performed by one or more processing devices, of processing a signal of interest from a compound signal, the method comprising:
generating a matrix wherein each column is associated with a corresponding frequency bin of a plurality of frequency bins, each frequency bin extending over a portion of a bandwidth of the compound signal;
initializing a first row of the matrix to zero;
obtaining the compound signal in the form of a digital signal, with sampling rate S samples per second, from data storage or from conversion of a physical analog signal received from an analog source or captured by a physical analog device;
for each sample of the digital signal, recursively computing, using a processing device, a new entry for the matrix, wherein the computing comprises, for each frequency bin:
multiplying a previous row entry of a given frequency bin by r, where r is a constant greater than zero and less than 1, and
adding a current digital signal sample multiplied by a real constant and by e^{-i2πnf/S}, where f is a center frequency of the given frequency bin, S is the sampling rate, and n is a current sample number; and
at least one of storing the matrix, transmitting the matrix, displaying the matrix, and identifying the signal of interest from the matrix, whereby an uncertainty of which frequency bin the signal of interest exists in is eliminated.

8. The method of claim 7, wherein the real constant is 2*(1−r).

9. The method of claim 7, further comprising:
locating the frequency bins nearest to the signal of interest;
computing the rate that the phase in each of the two nearest frequency bins is rotating by inspecting multiple samples in each of the two nearest frequency bins;
computing an implied frequency of the signal of interest by adding the rotational rates to the frequencies of each of the two nearest frequency bins; and
storing, transmitting, or displaying the resulting implied signal frequency.

10. The method of claim 7, wherein the compound signal includes a plurality of other signals in addition to the signal of interest.

11. The method of claim 10, wherein the signal of interest has an amplitude that is at least 20 dB less than at least two of the plurality of other signals.

12. A method, performed by one or more processing devices, of processing a signal of interest from a compound signal, the method comprising:
generating an array wherein each element of the array is associated with a corresponding frequency bin of a plurality of frequency bins, each frequency bin extending over a portion of a bandwidth of the compound signal;
initializing the array to zero;
obtaining the compound signal in the form of a digital signal, with sampling rate S samples per second, from data storage or from conversion of a physical analog signal received from an analog source or captured by a physical analog device;
for each sample of the digital signal, recursively updating the array by:
for each frequency bin, where f is the center frequency of the bin:
multiplying the previous value for that bin in the array by the complex number r*e^{i2πf/S}, where r is an exponential decay constant greater than zero and less than 1, f is the center frequency of the bin, and S is the sampling rate; and
adding the new signal sample multiplied by a real constant;
saving this updated array as a new row in a matrix; and
at least one of storing the matrix, transmitting the matrix, displaying the matrix, and identifying the signal of interest from the matrix, whereby an uncertainty of which frequency bin the signal of interest exists in is eliminated.

13. The method of claim 12, wherein the real constant is 2*(1−r).

14. The method of claim 12, further comprising multiplying the value in each cell of the matrix by e^{-i2πnft}.

15. A method, performed by one or more processing devices, of processing a signal of interest from a compound signal, the method comprising:
generating an array wherein each element of the array is associated with a corresponding frequency bin of a plurality of frequency bins, each frequency bin extending over a portion of a bandwidth of the compound signal;
initializing the array to zero;
obtaining the compound signal in the form of a digital signal, with sampling rate S samples per second, from data storage or from conversion of a physical analog signal received from an analog source or captured by a physical analog device;
for each sample of the digital signal, recursively updating the array by:
for each frequency bin, where f is the center frequency of the bin:
multiplying the previous value for that bin in the array by r, where r is an exponential decay constant greater than zero and less than 1; and
adding the new signal sample multiplied by a real constant and by e^{-i2πnf/S}, where f is a center frequency of the given frequency bin, S is the sampling rate, and n is a current sample number;
saving this updated array as a new row in a matrix; and
at least one of storing the matrix, transmitting the matrix, displaying the matrix, and identifying the signal of interest from the matrix, whereby an uncertainty of which frequency bin the signal of interest exists in is eliminated.

16. The method of claim 15, wherein the real constant is 2*(1−r).

17. The method of claim 15, further comprising multiplying the value in each cell of the matrix by e^{-i2πnft}.

18. A method, performed by one or more processing devices, of processing a signal of interest from a compound signal, the method comprising:
generating a matrix wherein each column is associated with a corresponding frequency bin of a plurality of frequency bins, each frequency bin extending over a portion of a bandwidth of the compound signal;
initializing a first row of the matrix to zero;
obtaining the compound signal in the form of a digital signal, with sampling rate S samples per second, from data storage or from conversion of a physical analog signal received from an analog source or captured by a physical analog device;
performing a Fourier transform on the digital signal to populate each cell of the matrix with values;
multiplying the value in each cell of the matrix by the complex number e^{-i2πnf/S}, where n corresponds to the n'th sample in the matrix, f is the center frequency of the bin, and S is the sampling rate; and
at least one of storing the matrix, transmitting the matrix, displaying the matrix, and identifying the signal of interest from the matrix, whereby an uncertainty of which frequency bin the signal of interest exists in is eliminated.
